(19) United States
(12) Patent Application Publication
(10) Pub. No.: US 2012/0304870 A1
(43) Pub. Date: Dec. 6, 2012

(54) AUTOMATIC BREAD MAKER

(76) Inventors: Yasuyuki Ito, Tottori-shi (JP); Yoshinari Shirai, Tottori-shi (JP); Syuji Fukuda, Tottori-shi (JP)

(21) Appl. No.: 13/575,567

(22) PCT Filed: Jan. 31, 2011
(86) PCT No.: PCT/JP2011/051875

§ 371 Date: Jul. 26, 2012

(30) Foreign Application Priority Data
Feb. 10, 2010 (JP) 2010-027694

(51) Int. Cl. A47J 37/01

(52) U.S. Cl. 99/334; 99/342

(57) ABSTRACT

An automatic bread maker (1) receives in a body (10) a bread container into which bread ingredients have been loaded, and carries out a bread-making step. The automatic bread maker (1) comprises a first bread container (60) accommodated in the body (10) in the case that cereal grains are used as a starting ingredient; a second bread container (100) accommodated in the body (10) in the case that cereal flour is used as a starting ingredient; and a bread container detector (120) that is capable of detecting whether the bread container accommodated in the body (10) is the first bread container (60) or the second bread container (100).

### TECHNICAL FIELD

The present invention relates to an automatic bread maker used mainly in typical households.

### BACKGROUND ART

Automatic bread makers for home use on the market generally have a system to make bread in which a bread container, into which the bread ingredients are put, is used as the baking pan (e.g., refer to Patent Document 1). In such an automatic bread maker, a bread container into which bread ingredients have been put is first introduced into a baking compartment in the body. The bread ingredients in the bread container are subsequently kneaded into a dough using a kneading blade provided in the bread container (kneading step). A fermentation step is then performed to ferment the kneaded dough, and the bread is baked using the bread container as the baking pan (baking step).

Conventionally, flour (wheat flour, rice flour, and the like) produced by milling a cereal such as wheat and rice, or mixed flour produced by mixing various supplementary ingredients into the milled flour, are required as bread-making ingredients when bread is made using such an automatic bread maker.

### LIST OF CITATIONS

### Patent Documents

[Patent Document 1] Japanese Laid-open Patent Application No. 2000-116526

### SUMMARY OF INVENTION

### Technical Problem

In typical households, a cereal is sometimes stored in a granular form, as with rice grain, instead of a powdered form. Therefore, it would be extremely convenient if it were possible to make bread directly from cereal grains using an automatic bread maker. Accordingly, after diligent study the present applicants have invented a method for making bread using cereal grains as a starting ingredient. The present applicants have already submitted a patent application (Japanese Published Unexamined Application No. 2008-201507).

The bread-making method for which an application has already been submitted will be introduced. In this bread-making method, cereal grains are first mixed with a liquid, and the mixture is ground by a grinding blade (grinding step). Then gluten, yeast and other ingredients, for example, are added to the paste-form ground flour obtained from the grinding step, and these bread ingredients are kneaded into a dough (kneading step). After the dough is fermented (fermentation step), the fermented dough is baked into bread (baking step).

Here, considering the convenience for the user, there is a need for a automatic bread maker configuration that is capable of handling the case in which rice grains and other cereal grains are used as starting ingredients and the case in which cereal flour such as wheat flour and rice flour are used as starting ingredients. In view whereof, the present applicants conducted considerable research and arrived at a configuration that is considered to be a preferred mode for differentiating bread containers for the case in which cereal grains are used as the starting ingredient and the case in which cereal flour is used as the starting ingredient. The bread container referred to herein is a container into which bread ingredients are put and to which a grinding blade and a kneading blade are provided.

However, in the case of a configuration in which such bread containers are differentiated, it has been found that there is a drawback in that the control unit of the automatic bread maker does not ascertain which bread container has been positioned in the automatic bread maker. The automatic bread maker is provided with a motor that rotates the grinding blade at high speed because the cereal grains (rice grains or the like) must be ground. In the case that the control unit of the automatic bread maker does not have information related to the positioned bread container, a situation may arise in which the grinding motor is errantly driven even though the bread container for using cereal flour (wheat flour, rice flour, or the like) as the starting ingredient has been positioned. When such a situation occurs, the bread ingredients inside the bread container will fly out and it may not be possible to make good quality bread. Also, in some cases, the user may face a hazardous situation.

In view of the above, an object of the present invention is to provide an automatic bread maker that is convenient for the user in that it can suitably handle the case in which cereal grains are used as the starting ingredients and the case in which cereal flour is used as the starting ingredient.

### Solution to Problem

In order to achieve the aforementioned object, an automatic bread maker of the present invention is an automatic bread maker for receiving in a body a bread container into which bread ingredients have been put, and executing a bread-making step, the automatic bread maker comprising: a first bread container accommodated in the body in the case that cereal grains are used as a starting ingredient; a second bread container accommodated in the body in the case that cereal flour is used as a starting ingredient; and a bread container detector that is capable of detecting whether the bread container accommodated in the body is the first bread container or the second bread container.

In accordance with the automatic bread maker of the present aspect, it is possible to determine whether the bread container accommodated in the body (e.g., the baking compartment) is the first bread container or the second bread container with the aid of the bread container detector. It is therefore possible to carry out suitable control that corresponds to the bread container accommodated in the body.

In the aspect described above, the bread container detector may detect that a bread container has been accommodated in the body only in the case that one of the first bread container and the second bread container has been accommodated in the body. Also, the bread container detector may have a first bread container detector for detecting that the first bread container has been accommodated in the body, and a second bread container detector for detecting that the second bread container has been accommodated in the body. In the case of the former, there can be one bread container detector. Also, in the case of the latter, a state in which no bread container is accommodated in the body can also be detected, which offers convenience.

In the aspect described above, a first motor for high-speed rotation and a second motor for low-speed rotation may be provided inside the body; and the first motor may be used in the case that a bread-making step is executed using the first bread container, and the first motor may not be used in the case that a bread-making step is executed using the second bread container. In the present aspect, the presence of the bread container detector makes it possible to avoid a situation in which the first motor for high-speed rotation is errantly driven in the case that the second bread container is accommodated in the body.

In the automatic bread maker of the above-described aspect, a first blade rotation shaft capable of causing a grinding blade and a first kneading blade to rotate is supported at a bottom part of the first bread container; a second blade rotation shaft capable of causing a second kneading blade to rotate is supported at a bottom part of the second bread container; a first motor used when the grinding blade is caused to rotate and a second motor used when the first kneading blade and the second kneading blade are caused to rotate are provided inside the body; and the first blade rotation shaft and the second blade rotation shaft can be caused to rotate by the driving of the first motor and can be caused to rotate by the driving of the second motor.

In accordance with the present aspect, the size of the body can be reduced in an automatic bread maker having a configuration in which the first bread container and the second bread container are differentiated. However, in the case of this configuration, the blade rotation shaft can be caused to rotate by the first motor (grinding motor), which is caused to rotate at high speed, whether the first bread container or the second bread container is in the body. Therefore, the situation in which the first motor, which rotates at high speed, is errantly driven may occur even when the second bread container is in the body. However, since the automatic bread maker of the present aspect is provided with the above-described bread container detector, it is possible to perform control so as to prevent a situation in which the first motor (rotating at high speed) is errantly operated when the second bread container is accommodated in the baking compartment.

Specifically, in the automatic bread maker of the aspect described above, a control unit may be provided for determining with the aid of the bread container detector whether the second bread container is accommodated in the body, and, in the case that the second bread container is determined to be accommodated inside the body, for performing control so that the first motor is not driven.

In the automatic bread maker of the above-described aspect, the bread container detector may be a switch that is turned on by a button being pressed. In accordance with the present aspect, the bread container detector has the merit of, e.g., being inexpensive to obtain.

An aspect of the automatic bread maker in the case that the bread container detector is composed of a switch may be one in which the first bread container is provided at a greater height than that of the second bread container; a flange part is formed on an edge of the aperture part of the second bread container; and the button is provided so as to be pressed by the flange part to set the switch in an “on” state in a state in which the second bread container has been accommodated in the body, and so as to not be pressed by the first bread container in a state in which the first bread container has been accommodated in the body.

Another aspect may be one in which a flange part is formed on an edge of the aperture part of the second bread container; a protruding part that protrudes in a position below the flange part is provided to the external wall of the first bread container; and the button is provided so as to be pressed by the protruding part to set the switch in an “on” state in a state in which the first bread container has been accommodated in the body, and so as to not be pressed by the second bread container in a state in which the second bread container has been accommodated in the body.

### Advantageous Effects of the Invention

In accordance with the present invention, it is possible to provide an automatic bread maker that is convenient for the user in that it can suitably handle the case in which cereal grains are used as the starting ingredients and the case in which cereal flour is used as the starting ingredient. Therefore, it can be expected that bread-making at home will become more accessible and popular.

### BRIEF DESCRIPTION OF THE DRAWINGS

FIG. 1 is a schematic perspective view showing a configuration of the external appearance of the automatic bread maker according to the present embodiment;

FIG. 2 is an illustrative diagram showing the configuration inside the body of the automatic bread maker of the present embodiment;

FIG. 3 is a partial cross-sectional view showing the schematic structure of the automatic bread maker of the present embodiment, and is a view showing a configuration in the case that the first bread container is used;

FIG. 4 is a view for illustrating the configuration of the grinding blade and the kneading blade used in the case that the first bread container is used in the automatic bread maker of the present embodiment, and is a schematic view as seen diagonally from below;

FIG. 5 is a view for illustrating the configuration of the grinding blade and the kneading blade used in the case that the first bread container is used in the automatic bread maker of the present embodiment, and is a schematic view as seen from below;

FIG. 6 is a top view of the first bread container in the automatic bread maker of the present embodiment when the kneading blade is in the folded orientation;

FIG. 7 is a top view of the first bread container in the automatic bread maker of the present embodiment when the kneading blade is in the open orientation;

FIG. 8 is a schematic perspective view showing a configuration of the guard provided to the automatic bread maker of the present embodiment;

FIG. 9 is a partial cross-sectional view showing of the schematic structure of the automatic bread maker of the present embodiment, and is a view showing a configuration in the case that the second bread container is used;

FIG. 10A is a cross-sectional view for illustrating the relationship between the hub of the second kneading blade and the second blade-rotating shaft in the second bread container;

FIG. 10B is a top view for illustrating the relationship between the hub of the second kneading blade and the second blade-rotating shaft in the second bread container;

FIG. 11 is a block diagram showing the configuration automatic bread maker of the present embodiment;

FIG. 12 is a schematic diagram describing the bread-making procedure carried out by the automatic bread maker of the present embodiment;

FIG. 13 is a partial cross-sectional view showing the schematic structure of the automatic bread maker of the first alternative mode, and is a view showing a configuration in the case that the first bread container is used; and

FIG. 14 is a partial cross-sectional view showing the schematic structure of the automatic bread maker of the first alternative mode, and is a view showing a configuration in the case that the second bread container is used.

### DESCRIPTION OF EMBODIMENTS

Embodiments of an automatic bread maker according to the present invention will be described in detail below with reference to the accompanying drawings. It is to be understood that any specific time, temperature, or other parameters that appear in this specification are merely examples and are not intended in any way to limit the content of the invention.

(Schematic Configuration of the Automatic Bread Maker)

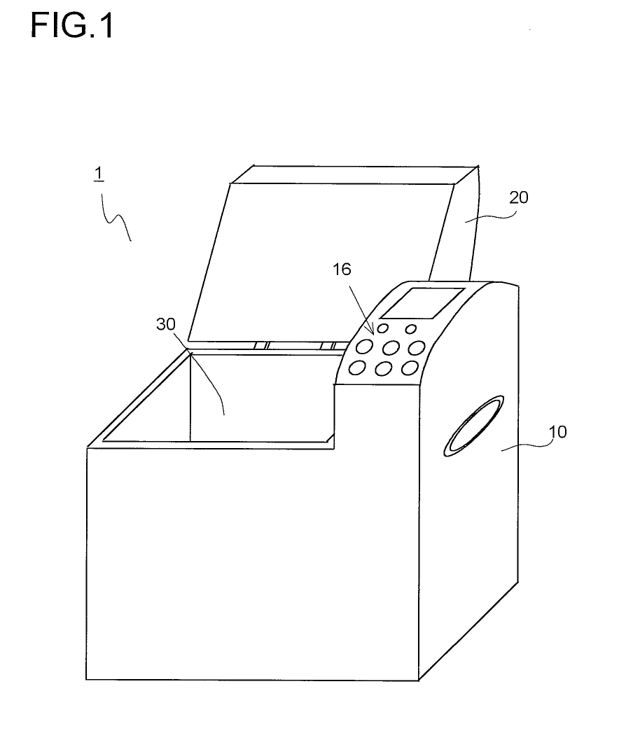

FIG. 1 is a schematic perspective view showing a configuration of the external appearance of the automatic bread maker according to the present embodiment. An operation part 16 is provided on the right side of the upper surface of the body 10 (formed, e.g., from a synthetic plastic) of the automatic bread maker 1, as shown in FIG. 1. The operation part 16 is provided with an operation key group such as a start key, a cancel key, a timer key, a reservation key, and a selection key for selecting a bread-making procedure; and a display unit for displaying a setup entered using the aforementioned operation keys, and errors or the like. Bread-making procedures include a procedure for making bread using rice grains as a starting ingredient, a procedure for making bread using rice flour as a starting ingredient, a procedure for making bread using wheat flour as a starting ingredient, and other procedures. Also, the display unit is composed of, e.g., a liquid crystal display panel, and indicator lamps using light emitting diodes as light sources.

A baking compartment 30 for accommodating the bread container (described in detail further below) is formed in the body 10 so as to be adjacent to the operation part 16. For example, the baking compartment 30, which is formed from sheet metal, is formed substantially in a rectangular shape as viewed from above and has an open upper surface. A lid 20 (formed, e.g., using a synthetic plastic) for covering the baking compartment 30 is provided to the body 10. The lid 20 is attached to the back surface of the body 10 by a hinge shaft (not shown), and the aperture of the baking compartment 30 can be opened and closed by swinging the lid about the hinge shaft. The lid 20 is provided with an observation window (not shown) made of, e.g., heat-resistant glass to allow the user to view the baking compartment 30.

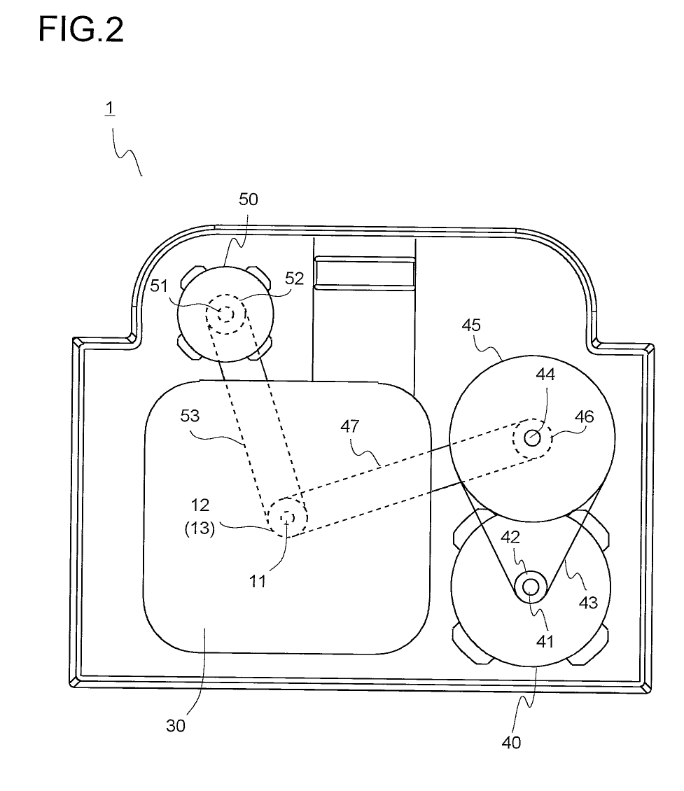

FIG. 2 is an illustrative diagram showing the configuration inside the body of the automatic bread maker of the present embodiment. FIG. 2 is a conceptual view showing a case in which the automatic bread maker 1 is viewed from above. A low-speed, high-torque kneading motor 40 used in the kneading step is disposed to the right of the baking compartment 30 in the automatic bread maker 1, as shown in FIG. 2. A high-speed-rotation grinding motor 50 used in the grinding step is securely disposed behind the baking compartment 30 in the automatic bread maker 1. The kneading motor 40 and the grinding motor 50 both have vertically oriented shafts. The kneading motor 40 is an example of the second motor of the present invention. The grinding motor 50 is an example of the first motor of the present invention.

A first pulley 42 is secured to an output shaft 41 that protrudes from the upper surface of the kneading motor 40. The first pulley 42 is connected to a second pulley 45 by a first belt 43. The second pulley 45 is formed having a greater diameter than the first pulley 42 and is secured to the upper end side of the rotating shaft 44. A third pulley 46 is secured to the lower end side of the rotating shaft 44. A clutch mechanism (not shown) is provided to the rotating shaft 44 between the portion to which the second pulley 45 is secured and the portion to which the third pulley 46 is secured. This clutch mechanism disposed between the second pulley 45 and the third pulley 46 makes it possible to switch between whether the rotary force of one pulley is to be transmitted to the other pulley. The third pulley 46 is connected to a first motor shaft pulley 12 (having substantially the same diameter as the third pulley 46) by a second belt 47. The first motor shaft pulley 12 is secured to a motor shaft 11 which is provided to the lower side of the baking compartment 30. The motor shaft 11 rotates at low speed and high torque when the kneading motor 40 is driven because the kneading motor 40 itself is a low-speed, high-torque motor and the first pulley 42 causes the second pulley 45 to rotate at low speed.

A fourth pulley 52 is secured to an output shaft 51 that protrudes from the lower surface of the grinding motor 50. The fourth pulley 52 is connected to a second motor shaft pulley 13 (secured further below the first motor shaft pulley 12) which is secured to the motor shaft 11 by a third belt 53. The second motor shaft pulley 13 has substantially the same diameter as the fourth pulley 52. A high-speed motor is selected as the grinding motor 50 and the fourth pulley 52 is kept rotating at substantially the same speed as the second motor shaft pulley 13. Accordingly, the motor shaft 11 rotates at high speed (e.g., 7000 to 8000 rpm) when the grinding motor 50 is driven.

When the grinding motor 50 is driven, the clutch mechanism provided between the above-described second pulley 45 and third pulley 46 is set in a state in which the rotation of both pulleys is not transmitted, and the rotation of the grinding motor 50 caused to rotate at high speed is not transmitted to the kneading motor 40.

The automatic bread maker 1 of the present embodiment is capable of baking bread using rice grains (an embodiment of cereal grains) as the starting ingredient, and is also capable of baking bread using wheat flour and rice flour (embodiments of cereal flour) as a starting ingredient. Different bread containers into which the bread ingredients are put are used for the case in which rice grains are used as the starting ingredients and the case in which wheat flour or rice flour is used as the starting ingredient. Hereinbelow, the first bread container is used for the case in which rice grains are used as the starting ingredients and the second bread container is used for the case in which wheat flour or rice flour is used as the starting ingredient. The configuration of the case in which the first bread container is used and the case in which the second bread container is used will be separately described.

1. Configuration of the Case in which the First Bread Container is Used

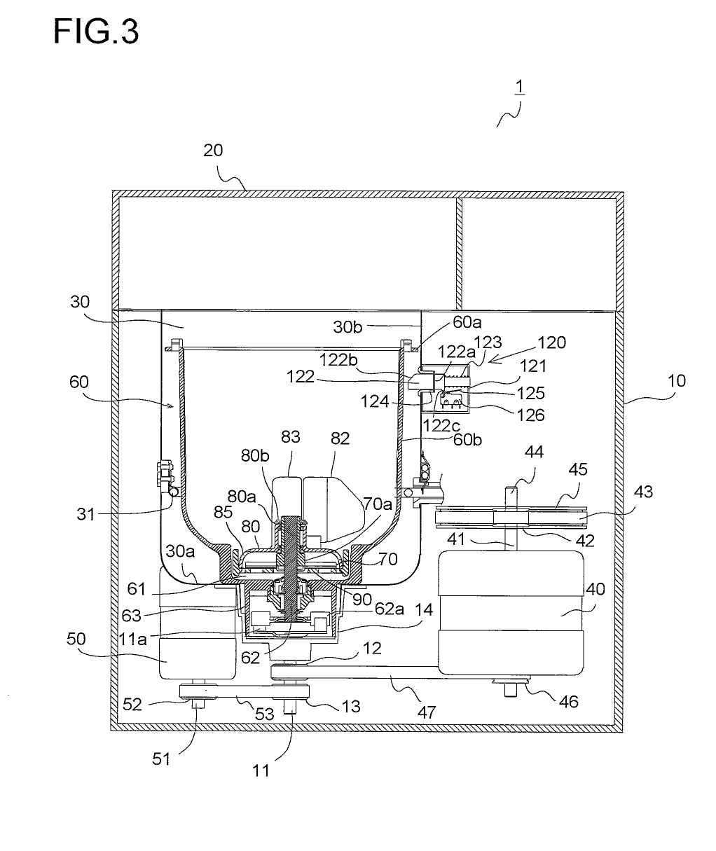

FIG. 3 is a partial cross-sectional view showing of the schematic structure of the automatic bread maker of the present embodiment, and is a view showing a configuration in the case that the first bread container is used. FIG. 3 is a conceptual view showing a case in which the automatic bread maker is viewed from the front.

A sheath heater 31 is disposed inside the baking compartment 30 so as to surround the first bread container 60 (which may be substituted for the second bread container 100 described below) accommodated in the baking compartment 31, as shown in FIG. 3. The bread ingredients inside the first bread container 60 (which may be substituted for the second bread container 100 described below) can be heated thereby.

A bread container support 14 for supporting the first bread container 60 (which may be substituted for the second bread container 100 described below) is secured to a location that is substantially the center of the bottom wall 30a of the baking compartment 30. The bread container support 14 comprises, e.g., a die-cast molding of an aluminum alloy. The bread container support 14 is formed so as to be depressed from the bottom wall 30a of the baking compartment 30 and the shape of the depression is substantially circular as viewed from above. The motor shaft 11 described above is vertically supported at the center of the bread container support 14.

The first bread container 60 is, e.g., a die-cast molding of an aluminum alloy. The bread container 60 has the shape of a bucket, and a handle (not shown) for gripping is mounted on a flange part 60a provided to edge of the aperture. The horizontal cross-section of the first bread container 60 is that of a rectangle with four rounded corners. A recess 61 having a substantially circular shape as viewed from above is formed in the bottom part of the first bread container 60 to accommodate a grinding blade 70 (described in detail hereafter) and a cover 80.

A vertically extending first blade rotation shaft 62 is supported at the center of the bottom part of the first bread container 60 in a state in which sealing has been applied. A container-side coupling member 62a is secured to the lower end of the first blade rotation shaft 62 (the lower end is located on the exterior of the bread container 60). A cylindrical pedestal 63 is provided to the exterior surface side of the bread container 60, and the bread container 60 is disposed in the baking compartment 30 in a state in which the pedestal 63 is received by the bread container support 14. The pedestal 63 may be formed separately from the first bread container 60 or may be integrally formed with the first bread container 60.

Projections (not shown) are formed on the internal circumferential surface of the bread container support 14 and the external circumferential surface of the pedestal 63, and these projections constitute a known bayonet coupling. In other words, when the first bread container 60 is to be mounted on the bread container support 14, the projections on the pedestal 63 are kept from interfering with the projections on the bread container support 14, and the first bread container 60 is lowered thereon. After the pedestal 63 is fitted into the bread container support 14, the projections of the pedestal 63 are designed to engage with the lower surfaces of the projections of the bread container support 14 when the first bread container 60 twists horizontally. The first bread container 60 is thereby prevented from slipping out upwards.

With this operation, the connecting (coupling) of the above-described container-side coupling member 62a provided to the first blade rotation shaft 62 and a motor shaft-side coupling member 11a secured to the upper end of the motor shaft 11 is also achieved at the same time. This coupling makes it possible for rotary force from the motor shaft 11 to be transmitted to the first blade rotation shaft 62.

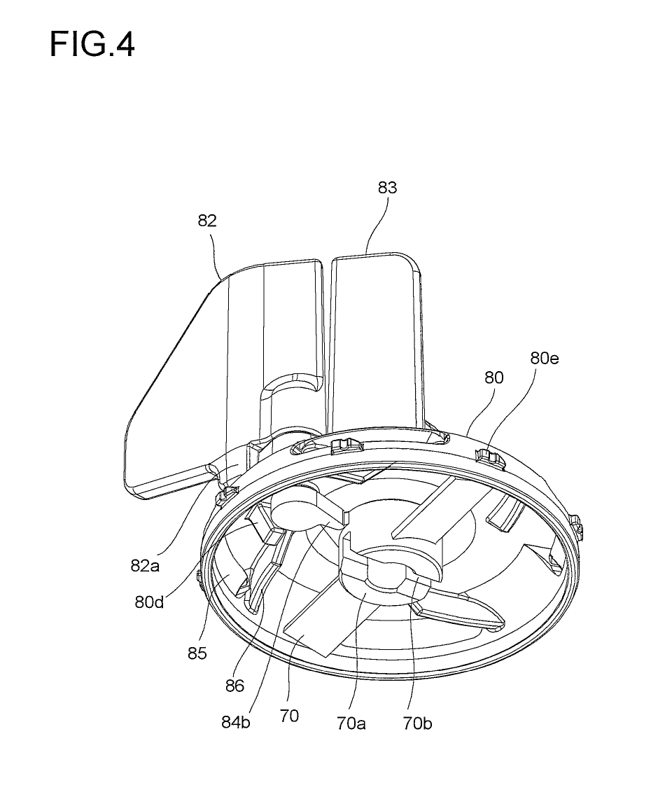

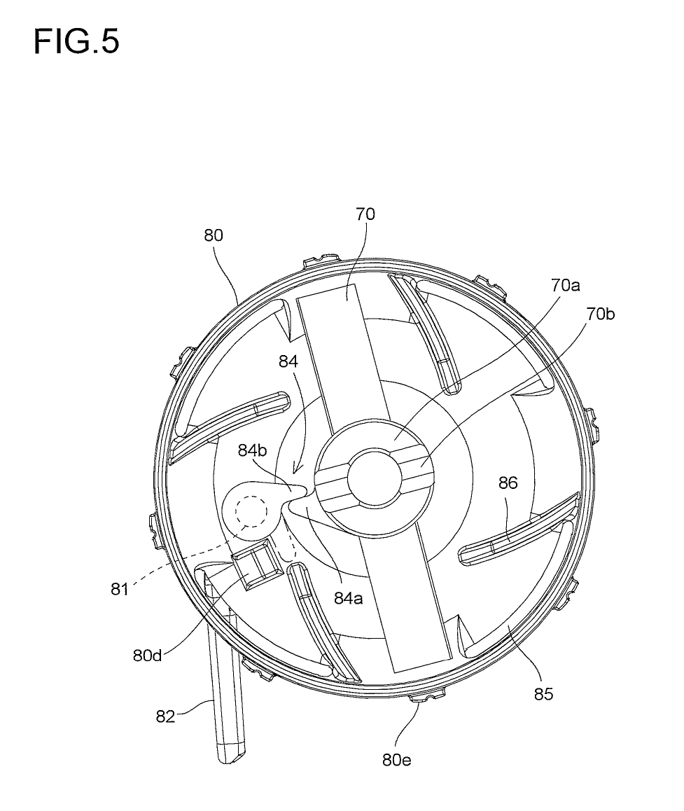

The grinding blade 70 is mounted on the first blade rotation shaft 62 at a location slightly above the bottom of the first bread container 60. A dome-shaped cover 80 having a substantially circular shape as viewed from above is mounted on the upper end of the first blade rotation shaft 62. FIG. 4 is a view for illustrating the configuration of the grinding blade and the kneading blade used in the case that the first bread container is used in the automatic bread maker of the present embodiment, and is a schematic view as seen diagonally from below. FIG. 5 is a view for illustrating the configuration of the grinding blade and the kneading blade used in the case that the first bread container is used in the automatic bread maker of the present embodiment, and is a schematic view as seen from below.

The grinding blade 70 (formed from, e.g., a stainless steel plate) has a shape similar to an airplane propeller and is mounted so as to be incapable of rotation in relation to the first blade rotation shaft 62, as shown in FIGS. 4 and 5. The center part of the grinding blade 70 is a hub 70a that fits onto the first blade rotation shaft 62. A groove 70b is formed in the lower surface of the hub 70a so as to traverse the hub 70a in the diameter direction. In the case that the grinding blade 70 is fitted onto the first blade rotation shaft 62 from above, a pin (not shown) that passes through the first blade rotation shaft 62 in the horizontal direction receives the hub 70a and engages the groove 70b, and the grinding blade 70 is connected so as to be unable to rotate with respect to the first blade rotation shaft 62.

The grinding blade 70 is configured so as to be simple to separate from the first blade rotation shaft 62; therefore, it can be cleaned after bread making and readily replaced when the edge thereof becomes dull.

A dome-shaped cover 80 (made of, e.g., a die-cast molding of an aluminum alloy) surrounds, covers, and conceals the grinding blade 70, as shown in FIG. 4. The cover 80 is rotatably supported by the hub 70a of the grinding blade 70 and is held on the hub 70a by a washer 80a and a retaining ring 80b (refer to FIG. 3). In other words, in the present embodiment, the grinding blade 70 and the cover 80 constitute an inseparable unit. The hub 70a of the grinding blade 70 is configured so as to serve additionally as a rotating shaft receiving part for receiving the first blade rotation shaft 62 in the cover 80.

The cover 80 can be easily pulled away from the first blade rotation shaft 62 together with the grinding blade 70, enabling cleaning to be readily performed after bread is made.

A kneading blade 82 (made of, e.g., a die-cast molding of an aluminum alloy), whose planar shape is a sideways V, is mounted on the exterior surface of the dome-shaped cover 80, and is mounted on a support shaft 81 (refer to FIG. 5) that extends in the vertical direction in a location set at a distance from the first blade rotation shaft 62. The support shaft 81 is fixed to or integrated with the kneading blade 82 and moves with the kneading blade 82.

In the present embodiment, a complementary kneading blade 83 is provided to the exterior surface of the cover 80 so as to align with the kneading blade 82. The complementary kneading blade 83 is not necessarily required, but is preferably provided in order to increase efficiency in the kneading step for kneading bread dough. In the case of the present configuration, the kneading blade 82 and the complementary kneading blade 83 are an embodiment of the first kneading blade of the present invention.

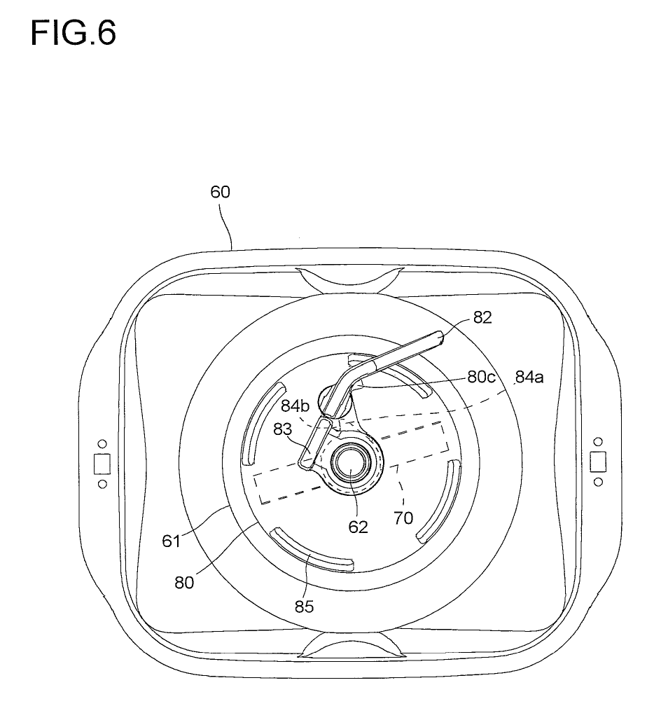

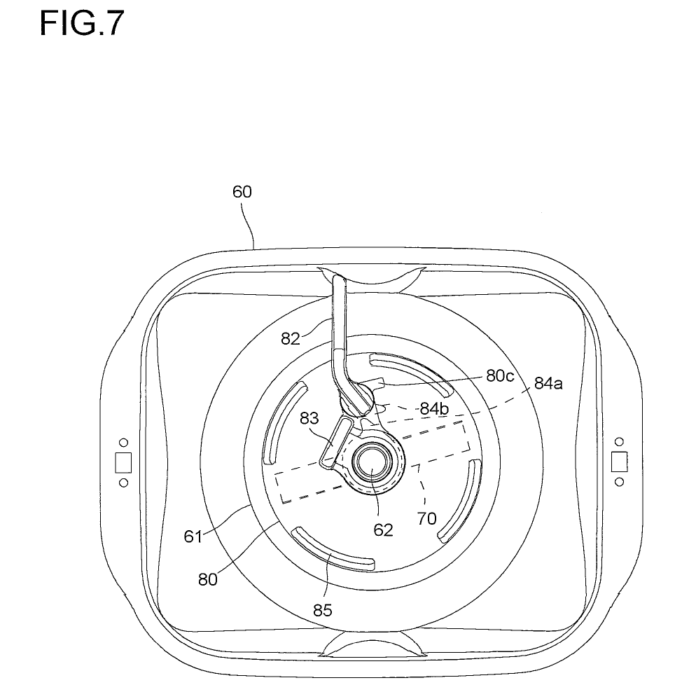

The operation of the kneading blade 82 will be described with reference to FIGS. 4 to 7. FIGS. 6 and 7 are views of the first bread container 60 as seen from above. The kneading blade 82 has a different orientation in FIGS. 6 and 7.

The kneading blade 82 rotates together with the support shaft 81 about the axis of the support shaft 81, and has two orientations: the folded orientation shown in FIG. 6, and the open orientation shown in FIG. 7. In the folded orientation, a projection 82a (refer to FIG. 4) suspended downward from the lower edge of the kneading blade 82 is in contact with a first stopper 80c provided to the upper surface of the cover 80. Accordingly, in the folded orientation, the kneading blade 82 cannot swing further in the clockwise direction (when viewed from above) in relation to the cover 80. At this time, the tip of the kneading blade 82 protrudes slightly from the cover 80. When the kneading blade 82 swings from this orientation in the counterclockwise direction (as viewed from above) and achieves the orientation shown in FIG. 7, the distal end of the kneading blade 82 protrudes considerably from the cover 80. The open angle of the kneading blade 82 in the open orientation is limited by a second stopper 80d (refer to FIGS. 4 and 5) provided to the interior surface of the cover 80. The kneading blade 82 is at the maximum open angle when a second engaging body 84b constituting a later-described clutch 84 (refer to FIG. 5) makes contact with the second stopper 80d and can no longer rotate.

In the case that the kneading blade 82 is in the folded orientation, the complementary kneading blade 83 is aligned with the kneading blade 82 as shown in FIG. 6, and the kneading blade 82 essentially having the shape of a sideways V is increased in size.

The clutch 84 is disposed between the cover 80 and the first blade rotation shaft 62, as shown in FIG. 5. The clutch 84 connects the first blade rotation shaft 62 and the cover 80 in the rotation direction of the first blade rotation shaft 62 when the kneading motor 40 causes the motor shaft 11 to rotate (this rotation direction is the “forward direction rotation,” and is the clockwise direction in FIG. 5). Conversely, the clutch 84 disconnects the first blade rotation shaft 62 from the cover 80 in the rotation direction of the first blade rotation shaft 62 when the grinding motor 50 causes the motor shaft 11 to rotate (this rotation direction is the “reverse direction rotation,” and is the counter-clockwise direction in FIG. 5). In FIGS. 6 and 7, the “forward direction rotation” is the counter-clockwise rotation direction and the “reverse direction rotation” is the clockwise rotation direction.

The clutch 84 will now be described in further detail. The clutch 84 is composed of a first engaging body 84a and the second engaging body 84b. The first engaging body 84a is secured to the hub 70a of the grinding blade 70 or is integrally formed with the hub 70a. In other words, the grinding blade 70 is mounted on the first blade rotation shaft 62 and the first engaging body 84a is mounted on the first blade rotation shaft 62 so as to be unable to rotate. The second engaging body 84b is secured to the support shaft 81 of the kneading blade 82 or integrally formed with the support shaft 81, and varies in angle in accompaniment with the change in orientation of the kneading blade 82.

In the case that the kneading blade 82 is in the folded orientation (e.g., the state of FIG. 5), the second engaging body 84b is positioned at an angle at which there is interference with the rotation trajectory of the first engaging body 84a. Therefore, the first engaging body 84a and the second engaging body 84b engage when the first blade rotation shaft 62 rotates in the forward direction (rotation in the clockwise direction in FIG. 5, and rotation in the counterclockwise direction in FIG. 6), and the rotary force of the first blade rotation shaft 62 is transmitted to the cover 80 and the kneading blade 82.

On the other hand, in the case that the kneading blade 82 is in the open orientation (the state of FIG. 7), the second engaging body 84b is at an angle at which there is not interference with the rotation trajectory of the first engaging body 84a. Therefore, even when the first blade rotation shaft 62 rotates in the reverse direction (rotation in the clockwise direction in FIG. 7), the first engaging body 84a and the second engaging body 84b do not engage with each other. The rotary force of the first blade rotation shaft 62 accordingly is not transmitted to the cover 80 and the kneading blade 82. It is apparent from the above that the clutch 84 switches the connection state between the first blade rotation shaft 62 and the cover 80 using the orientation of the kneading blade 82.

A window 85 that provides communication between the interior space of the cover and the exterior space of the cover is formed in the cover 80, as shown in FIGS. 4 and 5. The window 85 is disposed at the same height as the grinding blade 70 or in a position thereabove. In the present embodiment, four windows 85 are arranged at 90° intervals, but any number and arrangement interval may be used.

Also, four ribs 86 are formed in corresponding fashion to the windows 85 on the interior surface of the cover 80. The ribs 86 extend diagonally in the radial direction from near the center of the cover 86 to the annular wall of the external periphery, and the four ribs together constitute a type of spiral shape. The ribs 86 curve so that the sides facing the bread ingredients, which are pressed toward the ribs, are convex.

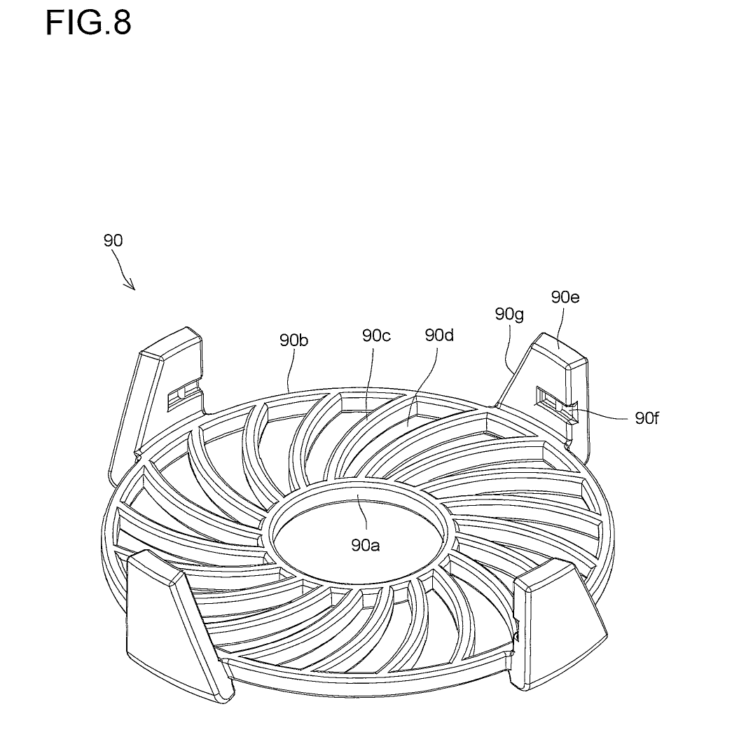

As is also shown in FIG. 3, a guard 90 is detachably mounted on the lower surface of the cover 80. The guard 90 covers the lower surface of the cover 80 and blocks the user's finger from coming near the grinding blade 70. The guard 90 is formed from, e.g., a heat resistant engineering plastic and is a molded article composed of, e.g., polyphenylene sulfide (PPS) or the like. FIG. 8 is a schematic perspective view showing a configuration of the guard provided to the automatic bread maker of the present embodiment.

A ring-shaped hub 90a through which the first blade rotation shaft 62 passes is provided in the center of the guard 90, as shown in FIG. 8. A ring-shaped rim 90b is provided to the peripheral edge of the guard 90. The hub 90a and the rim 90b are connected by a plurality of spokes 90c. The spaces between the spokes 90c constitute an aperture part 90d through which rice grains ground by the grinding blade 70 pass. The size of the aperture part 90d is not large enough to allow a finger to pass through.

The guard 90 is proximate to the grinding blade 70 when mounted on the cover 80. The guard 90 has the appearance of an outer blade of a rotary electric shaver and the grinding blade 70 has the appearance of an inner blade.

Four columns 90e are integrally molded at 90° intervals at the peripheral edge of the rim 90b (it being apparent that no limitation is imposed by there being four columns). A horizontal groove 90f with a terminus at one end is formed on the side surface of the columns 106e facing the center side of the guard 90. Protrusions 80e (eight of which also being disposed at 45° intervals in the present embodiment) formed on the external periphery of the dome-shaped cover 80 engage the groove 90f, whereby the guard 90 is mounted on the cover 80. The groove 90f and the protrusions 80e are provided so as to constitute a bayonet coupling.

2. Configuration of the Case in which the Second Bread Container is Used

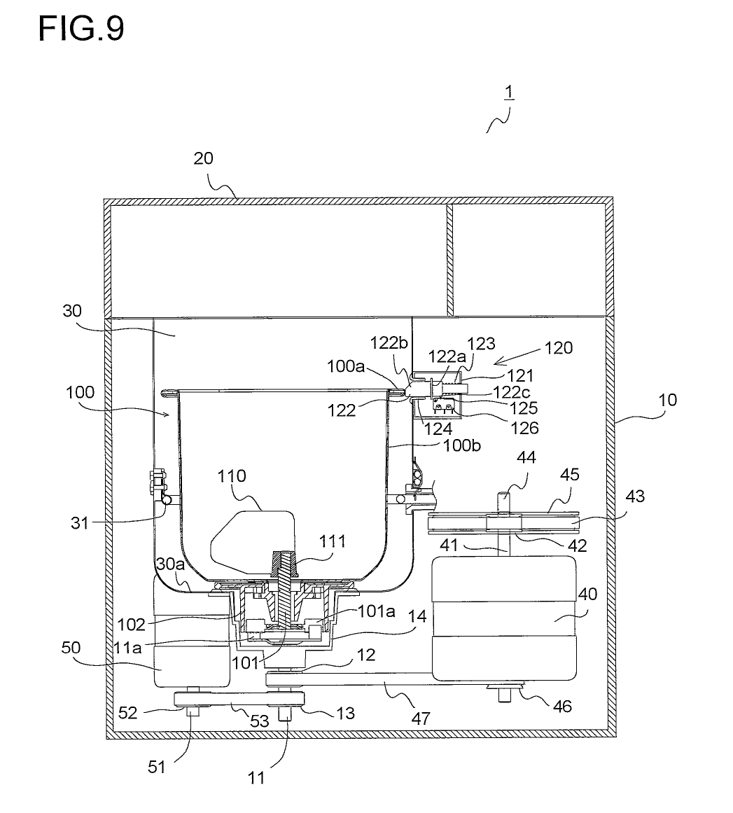

FIG. 9 is a partial cross-sectional view of the schematic structure of the automatic bread maker of the present embodiment, and is a view showing a configuration in the case that the second bread container is used. FIG. 9 is a conceptual view showing the case in which the automatic bread maker is viewed from the front. The duplicative configuration of the case in which the first bread container 60 is used will be omitted from the description unless such description is particularly required.

The second bread container 100 (made of, e.g., sheet metal) has the shape of a bucket as does the first bread container 60, and a handle (not shown) for gripping is mounted on a flange part 100a provided to edge of the aperture part. The horizontal cross-section of the second bread container 100 is also a rectangle with four rounded corners. However, a recess 61 such as the first bread container 60 has is not formed in the bottom part of the second bread container 100. This is related to the fact that there is no grinding step in the case that the second bread container 100 is used and there is no need to mount a grinding blade 70. Also, the second bread container 100 is lower in height than the first bread container 60 because the recess 61 is not required.

A vertically extending second blade rotation shaft 101 is supported at the center of the bottom part of the second bread container 100 in a state in which sealing has been applied. A container-side coupling member 101a is secured to the lower end of the second blade rotation shaft 101 (the lower end is located on the exterior of the second bread container 100). A cylindrical pedestal 102 is provided to the exterior surface side of the second bread container 100, and the second bread container 100 is disposed in the baking compartment 30 in a state in which the pedestal 102 is received by the bread container support 14.

The method for coupling the pedestal 102 and the bread container support 14 together is the same method as for coupling the pedestal 63 of the first bread container 60 and the bread container support 14 together. With the coupling of the pedestal 102 and the bread container support 14, the connecting (coupling) of the container-side coupling member 101a provided to the second blade rotation shaft 101 and a motor shaft-side coupling member 11a secured to the motor shaft 11 is also achieved. This coupling makes it possible for rotary force from the motor shaft 11 to be transmitted to the second blade rotation shaft 101.

A second kneading blade 110 (e.g., a die-cast molding of an aluminum alloy) is mounted on the upper end of the second blade rotation shaft 101. The second kneading blade 110 has a shape that appears as if the kneading blade 82 and the aforedescribed complementary kneading blade 83 (the two constitute the first kneading blade) have been integrally formed, and the hub 111 of the second kneading blade 110 is connected to the upper end of the second blade rotation shaft 101 so as to be incapable of rotating.

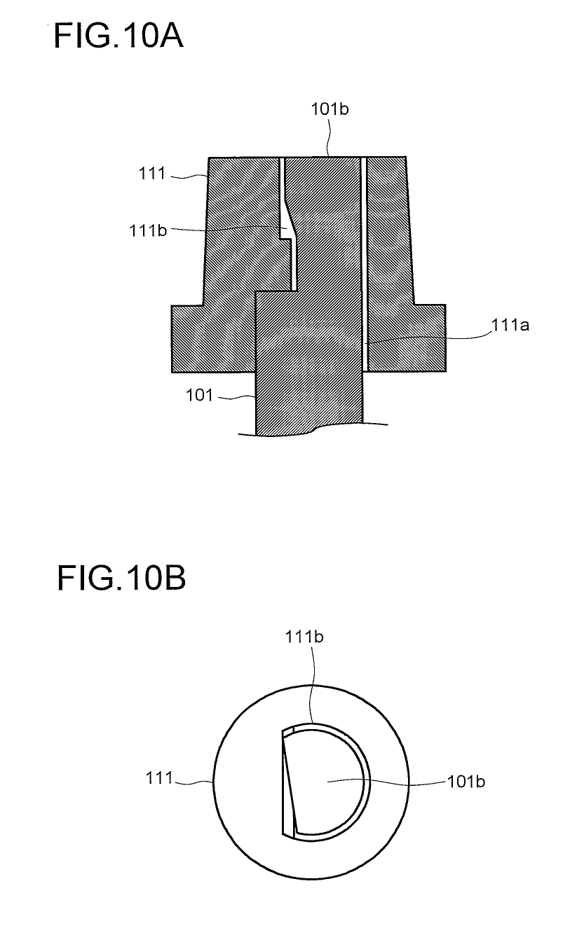

FIGS. 10A and 10B are views for illustrating the relationship between the hub of the second kneading blade and the second blade-rotating shaft in the second bread container, wherein FIG. 10A is a cross-sectional view and FIG. 10B is a top view. A center hole in the hub 111 of the second kneading blade 110 is a circular hole part 111a from the lower end to a predetermined height, but thereabove is a D-shaped hole part 111b. The D-shaped hole part 111b has a stepped structure in which the lower part of the portion that corresponds to the straight line of the D shape protrudes toward the center of the second blade rotation shaft 101. On the other hand, the second blade rotation shaft 101 is circular in cross section up until a slight distance short of the upper end, and thereabove is the D-shaped cross-sectional part 101b. The D-shaped cross-sectional part 101b has a stepped structure in which the upper part of the portion that corresponds to the straight line of the D shape protrudes outward in converse fashion to the D-shaped hole part 111b.

The D-shaped hole part 111b and the D-shaped cross-sectional part 101b are combined so that the protruding portion of the D-shaped cross-sectional part 101b overhangs the protruding portion of the D-shaped hole part 111b. The hub 111 of the second kneading blade 110 thereby connects to the second blade rotation shaft 101 so as to be unable to rotate. Since there is leeway in fitting the hub 111 and the second blade rotation shaft 101 together, the second blade rotation shaft 101 can be readily passed through the hub 111 to obtain the above-described overhang state. When power is transmitted to the second blade rotation shaft 101, the angle between the D-shaped hole part 111b and the D-shaped cross-sectional part 101b is offset and the protruding portions catch on each other, as shown in FIG. 10B. The second kneading blade 110 does not therefore readily dislodge from the second blade rotation shaft 101.

(Configuration of the Bread Container Detector Provided to the Automatic Bread Maker)

The schematic structure of the automatic bread maker 1 of the present embodiment was described above, and next described is the configuration of the bread container detector, which is a feature of the automatic bread maker 1 of the present embodiment.

A micro-switch 120, which is an embodiment of the bread container detector, is mounted on one of the four sidewalls 30b of the baking compartment 30 of the automatic bread maker 1, as shown in FIGS. 3 and 9. A body 121 of the micro-switch 120 is disposed and secured to the exterior surface side of the sidewall 30b of the baking compartment 30. A button 122 of the micro-switch 120 is fitted into an aperture provided in the sidewall 30b of the baking compartment 30 and the distal end of the button 122 is mounted in the baking compartment 30 so as to protrude toward the interior of the baking compartment 30.

The button 122 of the micro-switch 120 is urged toward the interior side (urging in the leftward direction in FIGS. 3 and 9) of the baking compartment 30 by a spring 123. A flange part 122a provided to the drum part of the button 122 makes contact with a protruding-distance limiting part 124, whereby the protruding distance of the button 122 from the sidewall 30b of the baking compartment 30 is adjusted to a predetermined distance. A sloped surface 122b is formed on the upper side of the distal end part of the button 122 so as to taper toward the distal end side.

The mounting position of the micro-switch 120 is adjusted so that the position of the button 122 is substantially the same height as the flange part 100a of the second bread container 100 accommodated in the baking compartment 30. The protruding distance of the button 122 from the sidewall 30b of the baking compartment 30 is adjusted so that the button 122 does not make contact with the sidewalls 60b, 100b of the bread container in a state which the first bread container 60 or the second bread container 100 is accommodated in the baking compartment 30. Also, the distance the button 122 protrudes from the sidewall 30b of the baking compartment 30 is adjusted so that the button 122 is pressed by the flange part 100a and the switch is turned on when the second bread container 100 is accommodated.

In the case that the second bread container 100 is accommodated in the baking compartment 30, the flange part 100a makes contact with the sloped surface 122b provided to the distal end side of the button 122, a force is applied to the button 122 in the opposite direction of the protruding direction of the button (the rightward direction in FIG. 9), and the button 122 begins to move. When this movement progresses a certain distance, a movable contact 125 makes contact with a fixed contact 126 when pressed by a protruding part 122c provided to the rear end side of the button 122, and sets the micro-switch 120 in an “on” state (the state of FIG. 9).

When the second bread container 100 is removed from the baking compartment 30, the button 122 is no longer pressed and the button 122 is therefore moved by the spring 123 in the direction facing the interior of the baking compartment 30 (the leftward direction in FIG. 9). The contact between the movable contact 125 and the fixed contact 126 is released and the “on” state of the micro-switch 120 is released (the micro-switch 120 is switched off).

On the other hand, the micro-switch 120 is not switched on in the case that the first bread container 60 is accommodated in the baking compartment 30, as shown in FIG. 3. As described above, the protruding distance of the button 122 from the sidewall 30b of the baking compartment 30 in the micro-switch 120 is adjusted so that there is no contact with the sidewall 60b of the first bread container 60. The first bread container 60 is configured having a recess 61 and is therefore higher than the second bread container 100. Accordingly, the flange part 60a most proximal to the sidewall 30b of the baking compartment 30 is positioned higher than the button 122 of the micro-switch 120 in the case that the first bread container 60 has been accommodated in the baking compartment 30. Therefore, the flange 60a does not press the button 122 of the micro-switch 120.

As described above, in the present embodiment, the micro-switch 120 is set in an “on” state in the case that the second bread container 100 has been accommodated in the baking compartment 30, but is not set in an “on” state in the case that the first bread container 60 has been accommodated in the baking compartment 30. In other words, the micro-switch 120 is a bread container detector for detecting that the second bread container 100 has been accommodated in the baking compartment 30.

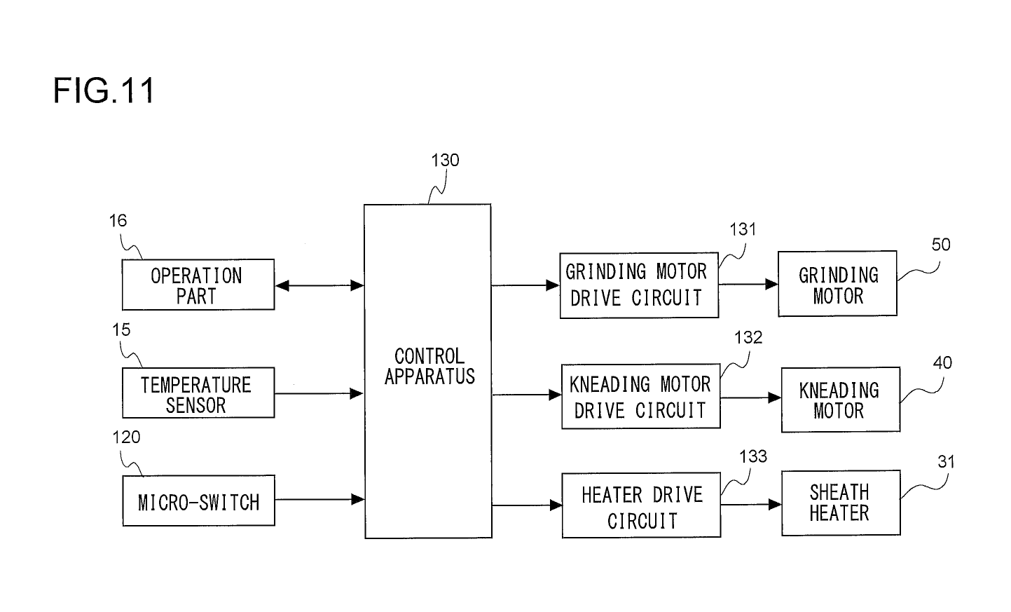

FIG. 11 is a block diagram showing the configuration of the automatic bread maker of the present embodiment. The micro-switch 120 is electrically connected to the control apparatus 130 (an example of the control unit of the present invention), which controls the operation of the automatic bread maker 1, as shown in FIG. 11. The control apparatus 130 can therefore determine whether the bread container accommodated in the baking compartment 30 is the first bread container 60 or the second bread container 100 by the on and off switching of the micro-switch 120. Specifically, in the case that the micro-switch 120 is in the “on” state, the second bread container 100 is determined to be accommodated in the baking compartment 30. In the case that the micro-switch 120 is in the “off” state, the first bread container 60 is determined to be accommodated in the baking compartment 30.

Thus, in the present embodiment, the control apparatus 130 can determine whether the bread container accommodated in the baking compartment 30 is the first bread container 60 or the second bread container 100, and the control apparatus 130 can therefore be made to carry out the following controls. For example, in the case that the second bread container 100 is accommodated in the baking compartment 30, an error can be displayed when an instruction for driving the grinding motor 50 has been inputted from the operation part 16 (in the case that a bread-making procedure which makes use of the grinding step has been selected). Also, for example, in the case that the second bread container 100 is accommodated in the baking compartment 30, a bread-making procedure for driving the grinding motor 50 cannot be selected from the beginning. It is thereby possible to avoid an event in which the grinding motor 50 is errantly caused to rotate (the second kneading blade 110 rotates in accompaniment therewith) and the bread ingredients fly out in the case that the second bread container 100 is accommodated in the baking compartment 30.

The control apparatus 130 is configured using a microcomputer (MCU) comprising, for example, a central processing unit (CPU), read only memory (ROM), random access memory (RAM), input/output (I/O) circuitry, and other components. The control apparatus 130 is preferably arranged in a position unlikely to be affected by the heat of the baking compartment 30. Further, the control apparatus 130 comprises a time measurement function, making it possible to perform time control in the bread-making step.

The operation part 16, the temperature sensor 15, the grinding motor drive circuit 131, the kneading motor drive circuit 132, and the heater drive circuit 133 are electrically connected to the control apparatus 130. The temperature sensor 15 is a sensor provided so that the temperature of the baking compartment 30 can be detected. The grinding motor drive circuit 131 is a circuit for controlling driving of the grinding motor 50 under instruction from the control apparatus 130. The kneading motor drive circuit 133 is a circuit for controlling driving of the kneading motor 40 under instruction from the control apparatus 130. The heater drive circuit 133 is a circuit for controlling the operation of the sheath heater 31 under instruction from the control apparatus 130.

The control apparatus 130 reads a program related to the procedure for making bread (bread-making procedure) stored in ROM or the like on the basis of an input signal from the operation part 16. The control apparatus 130 can carry out the steps for making bread in the automatic bread maker 1 while controlling the rotation of the grinding blade 70 via a grinding motor drive circuit 131, controlling the rotation of the second kneading blade 110 or the kneading blade 82 and the complementary kneading blade 83 via a kneading motor drive circuit 132, and controlling the heating operation of the sheath heater 31 via a heater drive circuit 133.

(Operation of the Automatic Bread Maker)

Next, the operation of the automatic bread maker 1 configured in the manner described above will be described for the case in which bread is made by the automatic bread maker 1. As described above, the automatic bread maker 1 of the present embodiment uses a different bread container for the case in which bread is made using rice grains as the starting ingredient and the case in which bread is made using milled flour such as wheat flour and rice flour as the starting ingredient. Therefore, the operation of the automatic bread maker 1 will be described for the case in which the first bread container 60 is used and the case in which the second bread container 100 is used.

1. When the First Bread Container is Used

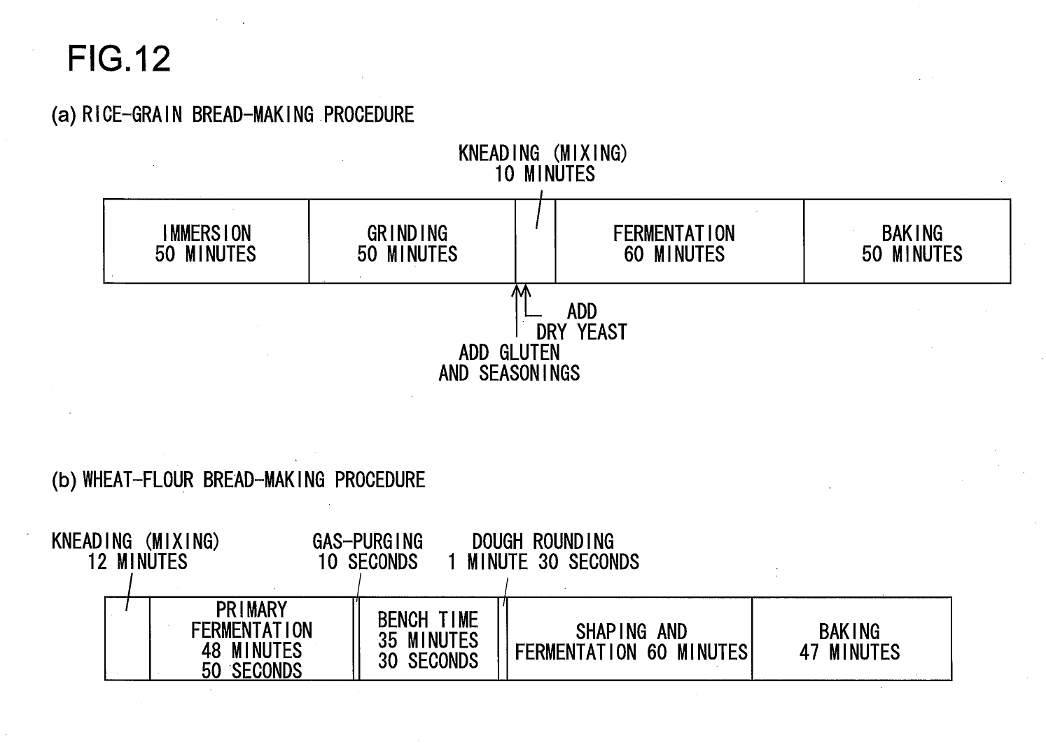

The first bread container 60 is used in the case of making bread using rice grains as the starting ingredient. The rice-grain bread-making procedure is carried out in the case that rice grains are used as the starting ingredient. FIG. 12 is an illustrative diagram showing the flow of a rice-grain bread-making procedure carried out by the automatic bread maker 1. In the rice-grain bread-making procedure, an immersion step, a grinding step, a kneading (mixing) step, a fermentation step, and a baking step are sequentially performed in the stated order, as shown in FIG. 12.

A user mounts the grinding blade 70 and the cover 80, on which the kneading blade 82 and the complementary kneading blade 83 are attached, in the first bread container 60 in order to perform the rice-grain bread-making procedure. The user then measures the respective predetermined amounts of rice grains and water and places them in the first bread container 60. Here, rice grains and water are mixed, but, for example, a liquid having a taste component such as a soup stock, fruit juice, a liquid containing alcohol, or another liquid may be used in place of plain water. The user then inserts the bread container 60, into which the rice grains and water have been put, into the baking compartment 30; closes the lid 20; selects a rice-grain bread-making procedure by operating the operation part 16; and presses the start key. The rice-grain bread-making procedure for making bread using rice grains as a starting ingredient is thereby started by the control apparatus 130.

The micro-switch 120 is not set in an “on” state in the case that the first bread container 60 has been accommodated in the baking compartment 30. The control apparatus 130 therefore determines that the bread container accommodated in the baking compartment 30 is the first bread container 60 and does not perform control to prevent a situation in which the grinding motor 50 is errantly driven. The user can therefore select the rice-grain bread-making procedure to start the bread-making procedure.

When the rice-grain bread-making procedure is started, the immersion step is started by instruction from the control apparatus 130. In the immersion step, the mixture of rice grains and water is left in a stationary state, and the stationary state is maintained for a predetermined time (50 minutes in the present embodiment) set in advance. In the immersion step, water is soaked with the rice grains, which is performed to facilitate the grinding of the rice grains to the cores in the grinding step performed subsequently.

The water-absorption speed of the rice grains varies with the water temperature. That is, the water-absorption speed increases with a high water temperature and decreases with a low water temperature. Accordingly, the time of the immersion step may be varied in accordance with, e.g., the ambient temperature in which the automatic bread maker 1 is used and other parameters. Variability in the water absorption of the rice grains can thereby be minimized. It is possible to energize the sheath heater 31 during the immersion step to increase the temperature of the baking compartment 30 in order to shorten the immersion time.

In the immersion step, the grinding blade 70 may be caused to rotate in the initial stage and the grinding blade 70 may be caused to rotate intermittently thereafter. Such a configuration makes it possible to scar the surfaces of the rice grains, improving the liquid-absorption efficiency of the rice grains.

When the above-noted predetermined time has elapsed, the immersion step is ended and the grinding step for grinding the rice grains is started by instruction from the control apparatus 130. In the grinding step, the grinding blade 70 is rotated at high speed in the mixture of rice grains and water. Specifically, the control apparatus 130 controls the grinding motor 50, causing the first blade rotation shaft 62 to rotate in the reverse direction and starting the grinding blade 70 rotating in the mixture of rice grains and water. The cover 80 then also starts to rotate in association with the rotation of the first blade rotation shaft 62, but the following operation immediately stops the cover 80 from rotating.

The rotation direction of the cover 80 associated with the rotation of the first blade rotation shaft 62 for causing the grinding blade 70 to rotate is clockwise in FIG. 6, and, in a case where the kneading blade 82 has been in the folded orientation (the orientation shown in FIG. 6), the kneading blade 72 is changed to the open orientation (the orientation shown in FIG. 7) by resistance from the mixture of the rice grains and water. When the kneading blade 82 moves to the open orientation, the second engaging body 84b departs from the rotation trajectory of the first engaging body 84a, and therefore the clutch 84 disconnects the first blade rotation shaft 62 from the cover 80. At the same time, the kneading blade 82 in the open orientation hits the inside wall of the first bread container 60 as shown in FIG. 7, inhibiting the rotation of the cover 80.

In the grinding step, the rice grains are ground in a state in which water has permeated the rice grains by the preceding immersion step, and therefore the rice grains can be readily ground to their cores. The grinding blade 70 rotates intermittently in the grinding step in the present embodiment. This intermittent rotation is performed, e.g., in a cycle in which rotation occurs for 30 seconds and is stopped for five minutes, and the cycle is repeated 10 times. In the final cycle, the five-minute stoppages are not performed. The grinding blade 70 may rotate continuously, but intermittent rotation is preferred in order, e.g., to prevent the temperature of the ingredients in the first bread container 60 from becoming excessively high.

The possibility that rice grains will fly out of the first bread container 60 in the grinding step is low because grinding is carried out inside the cover 80. The rice grains that enter into the dome-shaped cover 80 from the aperture part 90d of the guard 90, which is not rotating, are sheared between the rotating grinding blade 70 and the stationary spokes 90c and are therefore ground with good efficiency. Also, the rice grains are ground with good efficiency because the flow (flow in the same direction as the rotation of the grinding blade 70) of the rice-grain and water mixture is minimized by the ribs 86 provided to the cover 80.

The ground rice-grain and water mixture is guided by the ribs 86 in the direction of the windows 85 and discharged from the windows 85 to the exterior of the cover 80. The mixture is unlikely to pool on the surface of the ribs 86 and the mixture smoothly flows toward the windows 85 because the ribs 86 are curved so that the side facing the mixture, which presses against the ribs, is convex. The mixture present in the space above the recess 61 then enters into the recess 61, passes from the recess 61 through the aperture part 90d of the guard 90, and enters the cover 80 to replace the mixture that has been discharged from the interior of the cover 80. Grinding by the grinding blade 92 is carried out while the mixture is caused to circulate in this manner; therefore, grinding can be achieved with good efficiency.

The grinding step is ended in a predetermined length of time (50 minutes in the present embodiment) in the automatic bread maker 1. However, the hardness of the rice grains may vary, and the granularity of the ground flour may vary depending on ambient conditions. Therefore, it is possible to use a configuration in which the magnitude of the load (which can be determined by, e.g., the control current or the like of the motor) on the grinding motor 50 during grinding is used as an indicator for determining the end of the grinding step.

Upon completion of the grinding step, a kneading step is subsequently performed. The kneading step must be performed at a temperature (e.g., about 30° C.) at which the yeast can actively work. Therefore, the kneading step is preferably started when a predetermined temperature range has been reached. At the start of the kneading step, gluten, and flavor enhancers such as salt, sugar, and shortening are fed into the first bread container 60 in the respective amounts. These bread ingredients may, for example, be fed manually by the user, or automatically by providing an automatic feeding apparatus that will free the user from this task.

Gluten is not an essential bread ingredient. Gluten can therefore be added to the bread ingredients as deemed necessary by the user. A wheat flour or a thickening stabilizer (e.g., guar gum) may be fed together with, or instead of, gluten. The amount of seasonings such as salt, sugar, and shortening may be suitably modified in accordance with the preference of the user.

When the kneading step begins, the control apparatus 130 controls the kneading motor 40 so as to cause the first blade rotation shaft 62 to rotate in the forward direction. When the first blade rotation shaft 62 is caused to rotate in the forward direction, the grinding blade 70 also rotates in the forward direction and the bread ingredients around the grinding blade 70 flow in the forward direction. When the cover 80 moves in the forward direction in accompaniment therewith, the kneading blade 82 undergoes resistance from the bread ingredients that are not flowing and changes angle from an open orientation (refer to FIG. 7) to a folded orientation (refer to FIG. 6). When the second engaging body 84b reaches an angle that interferes with the rotation trajectory of the first engaging body 84a, the clutch 84 engages and the cover 80 is set at an attitude at which it is fully driven by the rotation of the first blade rotation shaft 62. The cover 80 and the kneading blade 82 in the folded orientation both rotate in the forward direction together with the first blade rotation shaft 62.

When the kneading blade 82 is in the folded orientation, the complementary kneading blade 83 aligns along the extension of the kneading blade 82 as if to enlarge the kneading blade 82, and the bread ingredients are forcibly pressed. The dough can therefore be thoroughly kneaded.

The rotation of the kneading blade 82 and the complementary kneading blade 83 in the kneading step may be continuous from beginning to end, but in the automatic bread maker 1, the rotation is intermittent in the initial stage of the kneading step and continuous in the latter half of the kneading step. In the present embodiment, yeast (e.g., dry yeast) is fed at the stage where the intermittent rotation carried out initially has ended. The yeast may be fed by the user, or may be automatically fed. The reason for not feeding the yeast with the gluten or the like is to prevent the yeast from coming into direct contact with water as much as possible. Depending on the situation, the yeast, gluten and the like may be fed simultaneously.

The bread ingredients are mixed and kneaded by the rotation of the kneading blade 82 and the complementary kneading blade 83 to become an integrated ball of dough having a prescribed elasticity. The kneading blade 82 and the complementary kneading blade 83 toss the dough about and beat it against the inside wall of the first bread container 60, adding the element of “kneading” to the mixing. The cover 80 also rotates together with the kneading blade 82 and the complementary kneading blade 83. When the cover 80 rotates, the ribs 86 formed on the cover 80 also rotate, and the bread ingredients inside the cover 86 are rapidly discharged from the windows 85. The discharged bread ingredients are assimilated into the mass (dough) of bread ingredients being kneaded by the kneading blade 82 and the complementary kneading blade 83.

In the kneading step, the guard 90 also rotates in the forward direction together with the cover 80. The spokes 90c of the guard 90 are shaped so that the center side of the guard 90 leads and the external peripheral side of the guard 90 trails during forward rotation. For this reason, the guard 90 rotates in the forward direction, whereby the bread ingredients inside and outside the cover 80 are pressed outward with the aid of the spokes 90c. The ratio of starting material that is discarded after the bread has been baked can thereby be reduced.

The bread ingredients at the periphery of the cover 80 are thrown upward at the front surface of the columns 90e during kneading because the columns 90e of the guard 90 are configured so that the side surfaces 90g (refer to FIG. 8) are sloped upward, the side surfaces 90g being the front surface in the direction of rotation when the guard 106 rotates in the forward direction. The ratio of starting material that is discarded after the bread has been baked can therefore be reduced.

In the automatic bread maker 1, the time for the kneading step may be a predetermined time (10 minutes in the present embodiment) obtained by experimentation as the time required to obtain a bread dough having desired elasticity. However, when the time for the kneading step is fixed, the quality of the bread dough may vary due to ambient temperature or another factor. Therefore, it is possible to use a configuration in which, e.g., the magnitude of the load on the kneading motor 40 (which can be determined by, e.g., the control current or the like of the motor) is used as an indicator for determining the end time of the kneading step.

When bread containing additional ingredients (e.g., raisins, nuts, and cheese) is baked, the additional ingredients can be fed during the kneading step.

When the kneading step is ended, a fermentation step is started according to an instruction from the control apparatus 130. In the fermentation step, the control apparatus 130 controls the sheath heater 31 and keeps the temperature of the baking compartment 30 to a temperature (e.g., 38° C.) that facilitates fermentation. The bread dough is left standing for a predetermined time (60 minutes in the present embodiment) in an environment that facilitates fermentation.

Depending on the situation, a process such as causing the kneading blade 82 and the complementary blade 83 to rotate, and causing the dough to deflate or become rounded may be performed during the fermentation step.

When the fermentation step is ended, a baking step is started by an instruction from the control apparatus 130. The control apparatus 130 controls the sheath heater 31 and increases the temperature of the baking compartment 30 to a temperature (e.g., 125° C.) suitable for baking bread. The control apparatus 120 performs control for baking the bread for a predetermined time (50 minutes in the present embodiment) under a baking environment. The user is notified of the end of the baking step by, e.g., a display on a liquid crystal display panel of the operation part 16, an audio alert, or the like. When the bread-making is detected to be complete, the user opens the lid 20 and removes the first bread container 60 to complete the bread making.

Bake marks of the kneading blade 82 remain in the bottom of the bread, but since the cover 80 and the guard 90 are accommodated in the recess 61, large bake marks are not left in the bottom of the bread.

2. When the Second Bread Container is Used

The second bread container 100 is used in the case of making bread using cereal flour such as wheat flour and/or rice flour as the starting ingredient. As an example, there is described below the case in which a wheat-flour bread-making procedure is carried out for making bread using wheat flour as the starting ingredient. FIG. 12 is an illustrative diagram showing the flow of a wheat-flour bread-making procedure carried out by the automatic bread maker 1. In the wheat-flour bread-making procedure, a kneading (mixing) step, a primary fermentation step, a gas-purging step, a dough rest step (also referred to as bench time and resting), a dough rounding step, a shaping and fermentation step, and a baking step are sequentially executed in the stated order, as shown in FIG. 12.

A user mounts the second kneading blade 110 in the second bread container 100 when the wheat-flour bread-making procedure is to be performed. The user places a predetermined amount of water in the second bread container 100, thereafter adds predetermined amounts of wheat flour, salt, sugar, and shortening, and lastly adds dry yeast to the second bread container 100 so that contact with the water is avoided. The amount of seasonings such as salt, sugar, and shortening may be suitably modified in accordance with the preference of the user. The user then inserts the second bread container 100 into the baking compartment 30, closes the lid 20, selects the wheat-flour bread-making course by operating the operation part 16, and presses the start key. The wheat-flour bread-making procedure for making bread using wheat flour as the starting ingredient is thereby started by the control apparatus 130.

The micro-switch 120 is set in an “on” state in the case that the second bread container 100 has been accommodated in the baking compartment 30. The control apparatus 130 therefore determines that the bread container accommodated in the baking compartment 30 is the second bread container 100 and performs control to prevent a situation in which the grinding motor 50 is errantly driven. In other words, the control apparatus 130, e.g., prohibits selection of the rice-grain bread-making procedure, or causes an error to be displayed if the rice-grain bread-making procedure is selected. The start of the rice-grain bread-making procedure is thereby prohibited.

When the wheat-flour bread-making procedure is started, the kneading step is started by an instruction from the control apparatus 130. When the kneading step begins, the control apparatus 130 controls the kneading motor 40 so as to cause the second blade rotation shaft 101 to rotate in the forward direction. The second kneading blade 110 is thereby caused to rotate at low speed and high torque. The rotation of the second kneading blade 110 is, e.g., initially extremely slow in the kneading step, and the speed is increased in a stepwise fashion under the control of the control apparatus 130.

The bread ingredients in the second bread container 100 are mixed and kneaded by the rotation of the second kneading blade 110 to become an integrated ball of dough having a prescribed elasticity. The second kneading blade 110 tosses the dough about and beats it against the inside wall of the second bread container 100, adding the element of “kneading” to the mixing. The kneading step is carried out for a predetermined time (12 minutes in the present embodiment) obtained by experimentation as the time required to obtain a bread dough having desired elasticity.

When bread containing additional ingredients (e.g., raisins, nuts, and cheese) is baked, the additional ingredients can be fed during the kneading step.

When the kneading step is ended, a primary fermentation step for allowing the bread dough to ferment is started according to an instruction from the control apparatus 130. When the primary fermentation step is started, the control apparatus 130 controls the sheath heater 31 and keeps the temperature of the baking compartment 30 at a predetermined temperature (32° C. in the present embodiment) that promotes fermentation. The primary fermentation step is carried out for 48 minutes 50 seconds in the present embodiment.

When the primary fermentation step is ended, a gas-purging step for purging gas contained in the bread dough is started according to an instruction from the control apparatus 130. In the gas-purging step, the control apparatus 130 controls the driving of the kneading motor 40 and causes the second kneading blade 110 to rotate continuously for a predetermined length of time (10 seconds in the present embodiment). In the gas-purging step, the control apparatus 130 also controls the sheath heater 31 in order keep the temperature of the baking compartment 30 at a predetermined temperature.

When the gas-purging step is ended, the dough rest step for resting the bread dough (also referred to as bench time and “resting”) is executed according to a command from the control apparatus 130. In this bench time, the control apparatus 130 controls the sheath heater 31 and keeps the temperature of the baking compartment 30 at a predetermined temperature (32° C. in the present embodiment). Bench time is carried out for 35 minutes 30 seconds in the present embodiment.

When the dough rest step is ended, a dough rounding step for rounding the bread dough is started according to an instruction from the control apparatus 130. In the dough rounding step, the control apparatus 130 controls the driving of the kneading motor 40 and causes the second kneading blade 110 to rotate. In the dough rounding step, the second kneading blade 110 is caused to rotate very slowly for a predetermined length of time (1 minute 30 seconds in the present embodiment).

When the dough rounding step is ended, a shaping and fermentation step for allowing the bread dough to ferment again is started according to an instruction from the control apparatus 130. In the shaping and fermentation step, the control apparatus 130 controls the sheath heater 31, keeps the temperature of the baking compartment 30 at a predetermined temperature (38° C. in the present embodiment) that promotes fermentation, and maintains this state for a predetermined length of time (60 minutes in the present embodiment).

When the shaping and fermentation step is ended, a baking step for baking the bread dough is carried out according to an instruction from the control apparatus 130. In the baking step, the control apparatus 130 controls the sheath heater 31 and increases the temperature of the baking compartment 30 to a temperature (120° C. in the present embodiment) suitable for baking bread. The bread for a predetermined time (47 minutes in the present embodiment) under a baking environment. The user is notified of the end of the baking step, e.g., by a display on a liquid crystal display panel, an audio alert, or the like (neither is shown) on the operation part 16. When the bread-making is detected to be complete, the user opens the lid 20 and removes the second bread container 100 to complete the bread making.

(Alternative Mode of the Bread Container Detector Provided to the Automatic Bread Maker)

1. First Alternative Mode

In the case of the embodiment described above, the micro-switch 120 is not set in the “on” state in the case that neither the first bread container 60 nor the second bread container 100 has been placed in the baking compartment 30. Therefore, the control apparatus 130 determines that the first bread container 60 has been placed in the baking compartment 30 in the additional case that the neither of the bread containers has been placed in the baking compartment 30. In other words, the above-described control for preventing a situation in which the grinding motor 50 is errantly driven is not carried out in the case that neither of the bread containers has been placed in the baking compartment 30. There is accordingly a possibility that the motor shaft 11 will be caused to rotate at high speed by the grinding motor 50 in a state in which a bread container is not accommodated in the baking compartment 30, and the user may be exposed to danger. In view of the above, it is possible to adopt a first alternative mode described below, which is different from the embodiment described above.

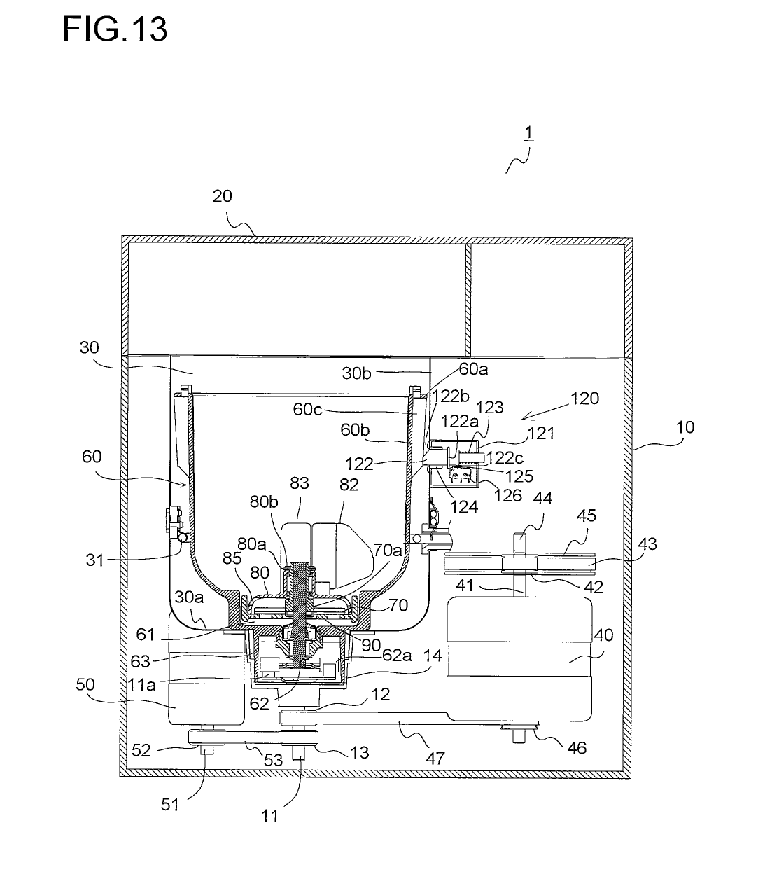

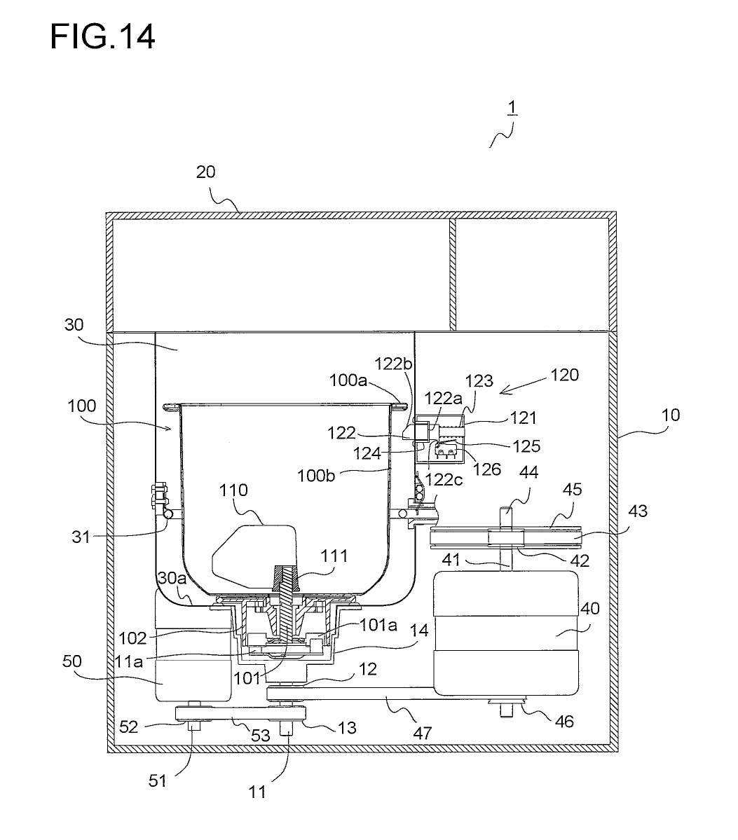

FIG. 13 is a partial cross-sectional view showing of the schematic structure of the automatic bread maker of the first alternative embodiment, and is a view showing a configuration in the case that the first bread container is used. FIG. 14 is a partial cross-sectional view showing of the schematic structure of the automatic bread maker of the first alternative embodiment, and is a view showing a configuration in the case that the second bread container is used. In the first alternative mode, the configuration of the first bread container 60 is slightly different from the case of above-described embodiment, as shown in FIG. 13.

Specifically, a tabular protrusion 60c substantially in the form of a trapezoid as seen in plan view is formed on the external sidewall 60b (a single side wall, or a plurality of sidewalls) of the first bread container 60. The protrusion 60c is configured so as to extend downward from near the upper end of the first bread container 60, and so that the lower end of the protrusion is positioned sufficiently lower than the flange part 100a of the second bread container 100.

In the first alternative mode, the automatic bread maker 1 is provided with the same micro-switch 120 as the embodiment described above, but the position of the button 122 is different from the case of the embodiment described above. In other words, the position of the button 122 of the micro-switch 120 is one facing a portion slightly above the lower end of the protrusion 60c of the first bread container 60 accommodated in the baking compartment 30 (the portion corresponding to a location slightly ahead of a tapered lower end side which begins to taper), and is a position lower than the flange part 100a of the second bread container 100 accommodated in the baking compartment 30.

The distance to which the button 122 protrudes from the sidewall 30b of the baking compartment 30 is adjusted so that the button does not make contact with the sidewalls 60b, 100b of the bread container in a state which the first bread container 60 or the second bread container 100 has been accommodated in the baking compartment 30 (this point is the same as the embodiment described above). The distance to which the button 122 protrudes from the sidewall 30b of the baking compartment 30 is adjusted so that the button 122 is pressed and the switch is turned on by the portion slightly above the above-described lower end of the protrusion 60c in a state in which the first bread container 60 has been accommodated (the distance to which this portion protrudes from the sidewall 60b of the first bread container 60 is about the same as the distance to which the flange 60a protrudes from sidewall 60b).

In the case that the first bread container 60 is accommodated in the baking compartment 30, the protrusion 60c makes contact with the sloped surface 122b provided to the distal end side of the button 122, a force is applied to the button 122 in the opposite direction of the protruding direction of the button (the rightward direction in FIG. 13), and the button 122 begins to move. When this movement progresses a certain distance, a movable contact 125 makes contact with a fixed contact 126 when pressed by a protruding part 122a provided to the rear end side of the button 122, and sets the micro-switch 120 in an “on” state (the state of FIG. 13).

On the other hand, the micro-switch 120 will not be switched on in the case that the second bread container 100 is accommodated in the baking compartment 30, as shown in FIG. 14. As described above, the distance to which the button 122 of the micro-switch 120 protrudes from the sidewall 30b of the baking compartment 30 is adjusted so that there is no contact with the sidewall 100b of the second bread container 100. The flange part 100a of the second bread container 100 is in a higher position than the button 122 of the micro-switch 120 in a state in which the second bread container 100 has been accommodated in the baking compartment 30. Therefore, the button 122 of the micro-switch 120 is not pressed even when the second bread container 100 has been accommodated in the baking compartment 30.

As described above, in the present embodiment, the micro-switch 120 is set in an “on” state in the case that the first bread container 60 has been accommodated in the baking compartment 30, but is not set in an “on” state in the case that the second bread container 100 has been accommodated in the baking compartment 30. In other words, the micro-switch 120 is a bread container detector for detecting that the first bread container 60 has been accommodated in the baking compartment 30.

In this configuration, in the case that neither the first bread container 60 nor the second bread container 100 has been placed in the baking compartment 30, the control apparatus 130 determines that the second bread container 100 has been placed in the baking compartment 30 because the micro-switch 120 is not in an “on” state. In this case, the above-described control for preventing a situation in which the grinding motor 50 is errantly driven is carried out by the control apparatus 130. It is therefore a possible to avoid a situation in which the motor shaft 11 is caused to rotate at high speed by the grinding motor 50 in a state in which a bread container is not accommodated in the baking compartment 30.

The protrusion 60c can be configured so as to be capable of pressing the button 122 provided in a position lower than the flange part 100a of the second bread container 100, and the protrusion is therefore not required to extend from near the upper end (corresponding to the configuration shown in FIG. 13). In other words, the first bread container 60 can be configured having a protrusion in a position lower than the flange part 100a of the second bread container 100 (preferably a position that is not excessively low), whereby the above-described bread container detector for detecting the first bread container 60 can be obtained.

2. Second Alternative Mode

In the embodiment and first alternative mode described above, the control apparatus 130 determines whether either of the bread containers has been placed in the baking compartment 30 even when there is no bread container in the baking compartment. Therefore, the configuration of the first bread container 60 is the same as the first alternative mode; and two micro-switches 120 may be prepared, it being possible for the two micro-switches 120 to be disposed in the position in the embodiment described above and the position in the first alternative mode. The case in which a bread container is not accommodated in the baking compartment 30 can thus be detected using a configuration in which a first bread container detector and a second bread container detector are provided for detecting different bread containers. In accordance with this configuration, it is also possible to detect the case in which the first bread container 60 has been accommodated in the baking compartment 30. In accordance with this configuration, it is furthermore possible to detect the case in which the second bread container 100 has been accommodated in the baking compartment 30.

### Other Embodiments

The embodiment described above (including the alternative mode) is an example of the present invention, but the configuration of an automatic bread maker in which the present invention is applied is not limited by the embodiments illustrated above.

The configuration of the micro-switch 120 as a bread container detector described above is an example. In other words, it is apparent that the configuration can be suitably modified as long as it is a switch that can achieve an “on” state using a button pressed by the accommodation of a bread container in the baking compartment 30.

In the description above, the bread container detector is configured using a micro-switch 120, the configuration allowing a specific bread container to be detected when the micro-switch 120 is actuated (is set in an “on” state) by a bread container being accommodated in the baking compartment 30. However, the present invention shall not be construed to be limited thereby. In other words, in certain cases, the configuration of the bread container detector may be one in which the “on” state of the switch is terminated by the accommodation of a bread container in the baking compartment 30, thereby making it possible to detect that a bread container has been accommodated in the baking compartment 30.

Also, in the embodiment described above, the bread container detector for detecting the bread container accommodated in the baking compartment 30 is configured using a switch. However, the present invention shall not be construed to be limited to this configuration, it also being possible to use a configuration in which, e.g., the bread container detector is a photo-interrupter or another optical sensor. A configuration for detecting only the flange part or the protrusion (formed on the sidewall of the bread container) of one of the first bread container 60 and the second bread container 100 can be implemented by disposing the optical sensor in a suitable position. In other words, it is possible to implement a configuration in which only one of the bread containers can be detected. Additionally, the bread container detector may be configured using a magnetic sensor or the like.

The rice grains in the embodiment described above are an example of cereal grains, and the wheat flour and rice flour are examples of cereal flour. The present invention may also be applied to an automatic bread maker configured to use, e.g., barley, millet, Japanese millet, buckwheat, corn, soy beans, or other cereal other than rice and wheat as the bread ingredients.

The bread-making steps carried out in the above-described rice-grain bread-making procedure and the wheat-flour bread-making procedure are examples; other steps may be employed. Another example of the rice-grain bread-making procedure is to carry out the immersion step again and thereafter carry out the kneading step in order to cause the ground flour to absorb the water after the grinding step.

### INDUSTRIAL APPLICABILITY

The present invention is suitably used in an automatic bread maker for household use.

### LIST OF REFERENCE SIGNS

1 automatic bread maker
10 body
40 kneading motor (second motor)
50 grinding motor (first motor)
60 first bread container
60c first bread container projection
62 first blade rotating shaft
70 grinding blade
82 kneading blade (a part of the first kneading blade)
83 complementary kneading blade (a part of the first kneading blade)
100 second bread container
100a second bread container flange
101 second blade rotating shaft
110 second kneading blade
120 micro-switch (bread container detector)
122 button
130 control apparatus (control unit)

1. An automatic bread maker for receiving in a body a bread container into which bread ingredients have been put, and executing a bread-making step, the automatic bread maker comprising:
a first bread container accommodated in the body in the case that cereal grains are used as a starting ingredient;
a second bread container accommodated in the body in the case that cereal flour is used as a starting ingredient; and
a bread container detector that is capable of detecting whether the bread container accommodated in the body is the first bread container or the second bread container.

2. The automatic bread maker of claim 1, wherein the bread container detector detects that a bread container has been accommodated in the body only in the case that one of the first bread container and the second bread container has been accommodated in the body.

3. The automatic bread maker of claim 1, wherein the bread container detector has a first bread container detector for detecting that the first bread container has been accommodated in the body, and a second bread container detector for detecting that the second bread container has been accommodated in the body.

4. The automatic bread maker of claim 1, wherein
a first motor for high-speed rotation and a second motor for low-speed rotation are provided inside the body; and
the first motor is used in the case that a bread-making step is executed using the first bread container, and the first motor is not used in the case that a bread-making step is executed using the second bread container.

5. The automatic bread maker of claim 1, wherein
a first blade rotation shaft capable of causing a grinding blade and a first kneading blade to rotate is supported at a bottom part of the first bread container;
a second blade rotation shaft capable of causing a second kneading blade to rotate is supported at a bottom part of the second bread container;
a first motor used when the grinding blade is caused to rotate and a second motor used when the first kneading blade and the second kneading blade are caused to rotate are provided inside the body; and
the first blade rotation shaft and the second blade rotation shaft can be caused to rotate by the driving of the first motor and can be caused to rotate by the driving of the second motor.

6. The automatic bread maker of claim 4, wherein a control unit is provided for determining with the aid of the bread container detector whether the second bread container is accommodated in the body, and, in the case that the second bread container is determined to be accommodated inside the body, for performing control so that the first motor is not driven.

7. The automatic bread maker of claim 1, wherein the bread container detector is a switch that is turned on by a button being pressed.

8. The automatic bread maker of claim 7, wherein
the first bread container is provided at a greater height that that of the second bread container;
a flange part is formed on an edge of the aperture part of the second bread container; and
the button is provided so as to be pressed by the flange part to set the switch in an on state in a state in which the second bread container has been accommodated in the body, and so as to not be pressed by the first bread container in a state in which the first bread container has been accommodated in the body.

9. The automatic bread maker of claim 7, wherein
a flange part is formed on an edge of the aperture part of the second bread container;
a protruding part that protrudes in a position below the flange part is provided to the external wall of the first bread container; and
the button is provided so as to be pressed by the protruding part to set the switch in an “on” state in a state in which the first bread container has been accommodated in the body, and so as to not be pressed by the second bread container in a state in which the second bread container has been accommodated in the body.
